(19) United States
(12) Patent Application Publication
(10) Pub. No.: US 2006/0072391 A1
(43) Pub. Date: Apr. 6, 2006

(54) Disc drive with improved resistance against mechanical shocks

(75) Inventor: Yu Zhou, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,356

(22) PCT Filed: Dec. 16, 2003
(86) PCT No.: PCT/IB03/06022

§ 371 Date: Jun. 15, 2005

(30) Foreign Application Priority Data
Dec. 19, 2002 (WO) PCT/SG02/00304

(51) Int. Cl. G11B 7/00

(52) U.S. Cl. 369/44.32; 369/44.28; 369/112.01; 369/53.18

(57) ABSTRACT

A disc drive apparatus (1) comprises; a) actuator means (50) for controlling the positioning of an element (34) of a scanning means; b) error signal calculating means (111, 112) for receiving a read signal (SR) and generating at least one error (RES; e(k)); c) a state estimator (120) for receiving said error and for outputting derived signals (s1, s2, s3); d) shock detector means (130) for generating a shock indication signal (SIS); e) actuator control signal generator means (190) designed to perform sliding mode control (SMC), having at least one variable control parameter, for generating an actuator control signal (RAD; u(k)) on the basis of a second one (s2) of said derived signals; f) the actuator control signal generator means setting a first value for said variable control parameter during normal operation, and setting a second value for said variable control parameter when said shock indication signal indicates the occurrence of a shock.

### FIELD OF THE INVENTION

The present invention relates in general to an optical disc drive apparatus for writing/reading information into/from an optical storage disc.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writeable type, where information may be stored by a user. For writing information in the storage space of the optical storage disc, or for reading information from the disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

For rotating the optical disc, an optical disc drive typically comprises a motor, which drives a hub engaging a central portion of the optical disc. Usually, the motor is implemented as a spindle motor, and the motor-driven hub may be arranged directly on the spindle axle of the motor.

For optically scanning the rotating disc, an optical disc drive comprises a light beam generator device (typically a laser diode), an objective lens for focussing the light beam in a focal spot on the disc, and an optical detector for receiving the reflected light reflected from the disc and for generating an electrical detector output signal. The optical detector comprises multiple detector segments, each segment providing an individual segment output signal.

During operation, the light beam should remain focussed on the disc. To this end, the objective lens is arranged axially displaceable, and the optical disc drive comprises focal actuator means for controlling the axial position of the objective lens. Further, the focal spot should remain aligned with a track or should be capable of being positioned with respect to a new track. To this end, at least the objective lens is mounted radially displaceable, and the optical disc drive comprises radial actuator means for controlling the radial position of the objective lens.

In many disc drives, the objective lens is arranged tiltably, and such optical disc drive comprises tilt actuator means for controlling the tilt angle of the objective lens.

For controlling these actuators, the optical disc drive comprises a controller, which receives an output signal from the optical detector. From this signal, hereinafter also referred to as read signal, the controller derives one or more error signals, such as for instance a focus error signal, a radial error signal, and, on the basis of these error signals, the controller generates actuator control signals for controlling the actuators such as to reduce or eliminate position errors.

In the process of generating actuator control signals, the controller shows a certain control characteristic. Such control characteristic is a feature of the controller, which may be described as the way in which the controller behaves as reaction to detecting position errors.

Position errors may, in practice, be caused by different types of disturbances. The two most important classes of disturbances are:
1) disc defects
2) external shocks and (periodic) vibration

The first category comprises internal disc defects like black dots, pollution like fingerprints, damage like scratches, etc. The second category comprises shocks caused by an object colliding to the disc drive, but shocks and vibrations are mainly to be expected in portable disc drives and automobile applications. Apart from the difference in origin, an important distinction between disc defects on the one hand and shocks and vibration on the other hand is the frequency range of signal disturbances: signal disturbances caused by disc defects are typically high-frequency, while shocks and vibrations are typically low-frequency.

A problem in this respect is that adequately handling shocks requires a different control characteristic than normal operating conditions.

Conventionally, the controller of a disc drive has a fixed control characteristic, which is either specifically adapted for adequately handling disturbances of the first category (in which case error control is not optimal in the case of disturbances of the second category) or specifically adapted for adequately handling disturbances of the second category (in which case error control is not optimal in the case of disturbances of the first category), or the control characteristic is a compromise (in which case error control is not optimal in the case of disturbances of the first category as well as in the case of disturbances of the second category). As long as a controller applies linear control technique, there is always a compromise between low-frequency disturbance rejection and high-frequency sensitivity to noise. For instance, a general way to obtain sufficient shock immunity in the present commercial products is to use lower damping suspensions with higher servo gain at the lower frequency side. However, the suspension design depends not only on the drive operational shock sensitivity but also on the suspension performance and dynamic range under all circumstances during operating, handling and transportation, and material cost, mechanical design tolerances etc. The lowering of the suspension damping rate to increase the shock immunity level is very much limited from the system point of view. Further more, the robustness to external shock by increasing the servo gain is also limited by the system stability requirements. A lower gain is also preferred to meet the design criteria of measurement noise rejection or to get less sensitivity to certain disc defects during playing.

In the state of the art, a switching control technique has already been proposed. For instance, reference is made to U.S. Pat. No. 4,722,079. Upon the occurrence of shock, a higher servo loop gain with higher lag filter is used. When the position error is less than a certain threshold, both the servo loop gain and the lag filter are switched back to the normal playing values.

Effective application of a switching control technique to suppress shock effects requires accurate detection of shock.

In order to be able to operate a controller having variable gain, it is necessary to accurately detect shocks. Utilizing a shock sensor is a direct method for accurate shock detection, but this will increase the product cost. Also, the system requirements of stability will limit the shock performance improvement. Said U.S. Pat. No. 4,722,079 describes a system where an optical read signal is processed to determine disturbance class, but this system requires a 3-beam optical system.

U.S. Pat. No. 5,867,461 also describes a system where an optical read signal is processed to determine disturbance class. In this known system, the envelope is determined of the high frequency signal contents. One disadvantage of this method is that it relies on data written on the disc; it is not applicable in the case of blank discs. Another disadvantage is that this method requires complicated circuitry, inter alia for detecting upper peaks and lower peaks, for filtering in order to detect upper envelope and lower envelope, for analysing these envelopes, and for storing signals in a memory.

Typically, actuator controllers comprise PID controllers. Increasing the gain of a PID controller only has a limited result.

A general objective of the present invention is to increase robustness, i.e. improve shock resistance of a disk drive apparatus with no or only limited increase of the cost of the apparatus.

Specifically, an objective of the present invention is to provide a disk drive apparatus having improved capability of shock control, which can be implemented relatively easily with no significant costs.

A further objective of the present invention is to provide a disk drive apparatus with an improved response characteristic to shocks.

### SUMMARY OF THE INVENTION

According to an important aspect of the present invention, the actuator controller comprises a Sliding Mode Controller. Advantageously, the present invention is implemented in software.

According to a specific aspect of the present invention, a shock is detected on the basis of an output signal of a state estimator. An important advantage is the fact that the state estimator is able to detect shocks early, so that the response time can be reduced.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1A schematically illustrates relevant components of an optical disc drive apparatus;

FIG. 1B illustrates an optical detector;

FIG. 2 is a block diagram schematically illustrating a control circuit;

FIG. 3 is a block diagram schematically illustrating a preferred embodiment of a state estimator;

FIG. 4 is a block diagram schematically illustrating an embodiment of a disturbance estimator;

FIG. 5 is a block diagram schematically illustrating an embodiment of an SMC controller;

FIG. 6 is a block diagram schematically illustrating an embodiment of a shock detector;

FIG. 7 is a graph showing the Bode plot of an radial actuator in an experimental simulation;

FIG. 8 is a graph showing the simulated results of the radial error signal off-track value in a case of shock;

FIG. 9 is a graph showing the radial error signal to illustrate the effect of the SMC controller.

### DESCRIPTION OF THE INVENTION

In the following, the present invention will be explained specifically for the radial control of an optical disc, specifically a DVD, without it being intended to restrict the scope of the present invention, since the present invention is likewise applicable to focus control and tilt control.

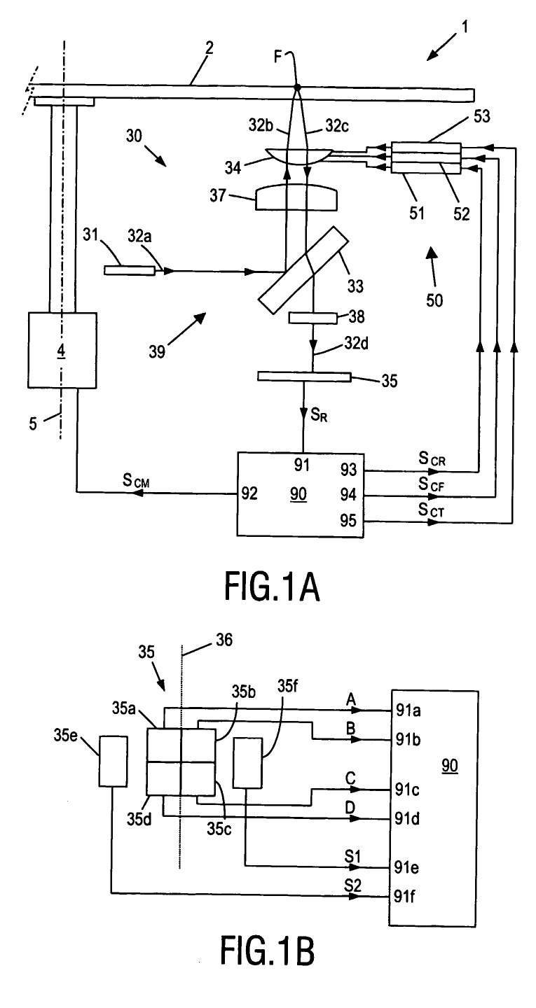

FIG. 1A schematically illustrates an optical disc drive apparatus 1, suitable for storing information on or reading information from an optical disc 2, typically a DVD or a CD. For rotating the disc 2, the disc drive apparatus 1 comprises a motor 4 fixed to a frame (not shown for sake of simplicity), defining a rotation axis 5.

The disc drive apparatus 1 further comprises an optical system 30 for scanning tracks (not shown) of the disc 2 by an optical beam. More specifically, in the exemplary arrangement illustrated in FIG. 1A, the optical system 30 comprises a light beam generating means 31, typically a laser such as a laser diode, arranged to generate a light beam 32. In the following, different sections of the light beam 32, following an optical path 39, will be indicated by a character a, b, c, etc added to the reference numeral 32.

The light beam 32 passes a beam splitter 33, a collimator lens 37 and an objective lens 34 to reach (beam 32b) the disc 2. The objective lens 34 is designed to focus the light beam 32b in a focal spot F on a recording layer (not shown for sake of simplicity) of the disc. The light beam 32b reflects from the disc 2 (reflected light beam 32c) and passes the objective lens 34, the collimator lens 37, and the beam splitter 33, to reach (beam 32d) an optical detector 35. In the case illustrated, an optical element 38 such as for instance a prism is interposed between the beam splitter 33 and the optical detector 35.

The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing, exactly on the desired location of the disc 2, said objective lens 34 is mounted axially displaceable, while further the actuator system 50 also comprises a focal actuator 52 arranged for axially displacing the objective lens 34 with respect to the disc 2. Since focal actuators are known per se, while further the design and operation of such focal actuator is no subject of the present invention, it is not necessary here to discuss the design and operation of such focal actuator in great detail. It is noted that the radial positioning system, which mainly carries out the seek action along the radial direction, is usually designed as a two-stage or sledge-actuator servo system, comprising a sledge for the large displacements of the laser spot along the radial direction (rough positioning). Alternatively, a swing arm can be used. The optical pick-up unit is movably mounted on the positioning means so that it can be controlled by the focus and radial actuators (riding on the sledge) for fine-positioning. In this respect, reference is made to: “Sorin G. Stan, “The CD-ROM Drive—A Brief System Description”, Kluwer Academic Publishers, 1998”. The dynamic interactions between radial and focus loops are relatively low. The radial and focus loops are usually designed and investigated separately in practical application. For the fine displacement, the focus and radial actuators are usually controlled by two separate PID controllers, thus creating two separate SISO (Single Input and Single Output) systems.

For achieving and maintaining a correct tilt position of the objective lens 34, the objective lens 34 may be mounted pivotably; in such case, as shown, the actuator system 50 also comprises a tilt actuator 53 arranged for pivoting the objective lens 34 with respect to the disc 2. Since tilt actuators are known per se, while further the design and operation of such tilt actuator is no subject of the present invention, it is not necessary here to discuss the design and operation of such tilt actuator in great detail.

It is further noted that means for supporting the objective lens with respect to an apparatus frame, and means for axially and radially displacing the objective lens, as well as means for pivoting the objective lens, are generally known per se. Since the design and operation of such supporting and displacing means are no subject of the present invention, it is not necessary here to discuss their design and operation in great detail.

It is further noted that the radial actuator 5 1, the focal actuator 52 and the tilt actuator 53 may be implemented as one integrated actuator.

The disc drive apparatus I further comprises a control circuit 90 having a first output 92 connected to a control input of the motor 4, having a second output 93 coupled to a control input of the radial actuator 51, having a third output 94 coupled to a control input of the focal actuator 52, and having a fourth output 95 coupled to a control input of the tilt actuator 53. The control circuit 90 is designed to generate at its first output 92 a control signal S_{CM} for controlling the motor 4, to generate at its second control output 93 a control signal S_{CR} for controlling the radial actuator 5 1, to generate at its third output 94 a control signal S_{CF} for controlling the focal actuator 52, and to generate at its fourth output 95 a control signal S_{CT} for controlling the tilt actuator 53.

The control circuit 90 further has a read signal input 91 for receiving a read signal S_{R} from the optical detector 35.

FIG. 1B illustrates that the optical detector 35 may comprise a plurality of detector segments. In the case illustrated in FIG. 1B, the optical detector 35 comprises six detector segments 35a, 35b, 35c, 35d, 35e, 35f, capable of providing individual detector signals A, B, C, D, S1, S2, respectively, indicating the amount of light incident on each of the six detector segments, respectively. Four detector segments 35a, 35b, 35c, 35d, also indicated as central aperture detector segments, are arranged in a four-quadrant configuration. A centre line 36, separating the first and fourth segments 35a and 35d from the second and third segments 35b and 35c, has a direction corresponding to the track direction. Two detector segments 35e, 35f, also indicated as satellite detector segments, and which may themselves be subdivided into subsegmnents, are arranged symmetrically besides the central detector quadrant, on opposite sides of said centre line 36. Since such six-segment detector is commonly known per se, it is not necessary here to give a more detailed description of its design and functioning.

It is noted that different designs for the optical detector 35 are also possible. For instance, the satellite segments may be omitted, as known per se.

FIG. 1B also illustrates that the read signal input 91 of the control circuit 90 actually comprises a plurality of inputs for receiving all individual detector signals. Thus, in the illustrated case of a six-quadrant detector, the read signal input 91 of the control circuit 90 actually comprises six inputs 91a, 91b, 91c, 91d, 91e, 91f for receiving said individual detector signals A, B, C, D, S1, S2, respectively. As will be clear to a person skilled in the art, the control circuit 90 is designed to process said individual detector signals A, B, C, D, S1, S2, in order to derive data signals and one or more error signals. A radial error signal, designated hereinafter simply as RE, indicates the radial distance between a track and the focal spot F. A focus error signal, designated hereinafter simply as FE, indicates the axial distance between a storage layer and the focal spot F. It is noted that, depending on the design of the optical detector, different formulas for error signal calculation may be used.

Generally speaking, such error signals each are a measure for a certain kind of asymmetry of the central optical spot on the detector 35, and hence are sensitive to displacement of the optical scanning spot with respect to the disc.

In the following discussion, signal values at current time will be indicated as signal(k); signal values at next time will be indicated as signal(k+1); signal values at previous time will be indicated as signal(k−1). Further, the actual value of a signal x will be indicated by the letter x without additions; a predicted value of this signal x will be indicated by \hat{x}; an estimated value of this signal x will be indicated by \overline{x}.

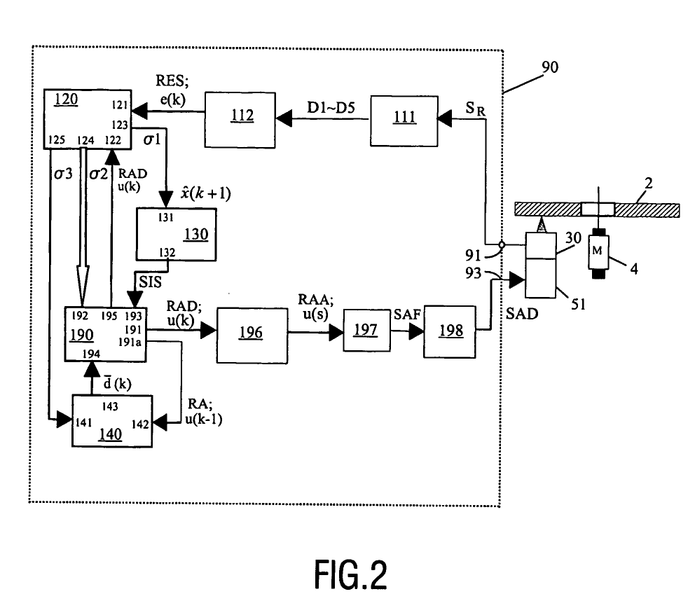

FIG. 2 is a block diagram schematically showing the control circuit 90 in more detail. The control circuit 90 comprises a signal pre-processing block 111 receiving the optical read signal SR from the OPU 30, and outputting individual diode signals D1˜D5. It is noted that the number of diode signals depends on the number of segments of detector 35.

The control circuit 90 further comprises an A/D signal processing block 11 2, receiving the output signals D1˜D5 from the signal pre-processing block 111, and outputting a radial error signal RES, also indicated as e(k).

The control circuit 90 further comprises an error signal processing block 120, having a first input 121 receiving the radial error signal e(k) from the A/D signal processing block 112. The error signal processing block 120 is designed to calculate derived signals from the radial error signal e(k), and has a first output 123 for outputting a first derived signal σ1, a second output 124 for outputting a second derived signal σ2, and a third output 125 for outputting a third derived signal σ3.

The control circuit 90 further comprises a shock detector block 130, having an input 131 receiving the first derived signal σ1 from the error signal processing block 120, and having an output 132 for outputting a shock indication signal SIS. The shock detector block 130 is designed to analyse the first derived signal σ1 from the error signal processing block 120 in relation to predefined conditions, and to generate the shock indication signal SIS as indicating the occurrence of a shock if such predefined conditions are met.

The control circuit 90 further comprises an actuator control signal generator block 190, having a first input 192 receiving the second derived signal σ2 from the error signal processing block 120, and having a second input 193 receiving the shock indication signal SIS from the shock detector block 130.

The control circuit 90 further comprises a disturbance estimator block 140, having a first input 141 receiving the third derived signal σ3 from the error signal processing block 120. The disturbance estimator block 140 has an output 143 for providing an estimated disturbance signal \overline{d}(k). The actuator control signal generator block 190 has a third input 194 receiving this estimated disturbance signal \overline{d}(k).

The actuator control signal generator block 190 is designed to calculate a digital radial actuator signal RAD, also indicated as u(k), on the basis of its input signals as mentioned, which digital radial actuator signal RAD is provided at a first output 191 and a second output 195.

The actuator control signal generator block 190 is further designed to calculate a digital radial actuator signal u(k−1) of previous time, on the basis of its input signals as mentioned, which digital radial actuator signal u(k−1) is provided at a third output 191a. The disturbance estimator block 140 has a second input 142 receiving this digital radial actuator signal u(k−1).

The control circuit 90 further comprises a D/A signal processing block 196, receiving the digital radial actuator signal RAD from the actuator control signal generator block 190, and outputting an analogue radial actuator signal RAA, also indicated as u(s).

The control circuit 90 further may comprise a noise filter block 197, receiving the analogue radial actuator signal u(s) from the D/A signal processing block 196, and outputting a filtered actuator signal SAF.

The control circuit 90 further comprises an actuator driver block 198, receiving the filtered actuator signal SAF from the noise filter block 197, and outputting an actuator drive signal SAD for the radial actuator 51.

The actuator control signal generator block 190 is designed to calculate its digital radial actuator output signal RAD on the basis of the second output signal σ2 as received from the error signal processing block 120. In this calculation, the actuator control signal generator block 190 shows a variable characteristic, typically a variable gain, and the actuator control signal generator block 190 is designed to set said variable characteristic (i.e. gain) on the basis of the shock indication signal SIS as received from the shock detector block 130. More particularly, if the shock indication signal SIS as received from the shock detector block 130 indicates the occurrence of a shock, the actuator control signal generator block 190 will set its variable characteristic to a value more suitable for operation in the case of shock (i.e. said gain is increased), and if the shock indication signal SIS as received from the shock detector block 130 indicates that the shock is over, the actuator control signal generator block 190 will set its variable characteristic to a value more suitable for normal operation (i.e. said gain is lowered). The shock indication signal SIS may in principle be generated in any suitable way; for instance, the shock detector block 130 may comprise a mechanical shock detector. Preferably, however, error signal processing block 120 is implemented as a state estimator, and the shock detector block 130 processes an output signal from the state estimator 120 to generate the shock indication signal SIS. The following description will be directed to this example.

According to an important aspect of the present invention, the actuator control signal generator block 190 is designed to implement sliding mode control (SMC). It is noted that sliding mode control is known per se. In this respect, reference is made to: “J. J. E. Slotine and W. Li, “Applied Nonlinear Control”, Englewood Cliffs, N.J.: Prentice-Hall, 1991”. An important advantage of this technique is its insensitivity to disturbances and the uncertain system.

The state estimator 120 is designed to estimate the entire state of the optical disc drive digital servo based on a measurement of one of the state elements. In the preferred embodiment shown, the state estimator 120 estimates the radial actuator position and the radial speed based on the measurement of the radial error signal RES.

More specifically, the state estimator 120 receives the current error signal e(k), and calculates an estimated value \overline{x}(k) for the current actuator position and an estimated value \overline{v}(k) for the current actuator speed. The estimated states are then used in the actuator control signal generator block 190 (SMC controller) to generate the digital radial actuator signal u(k).

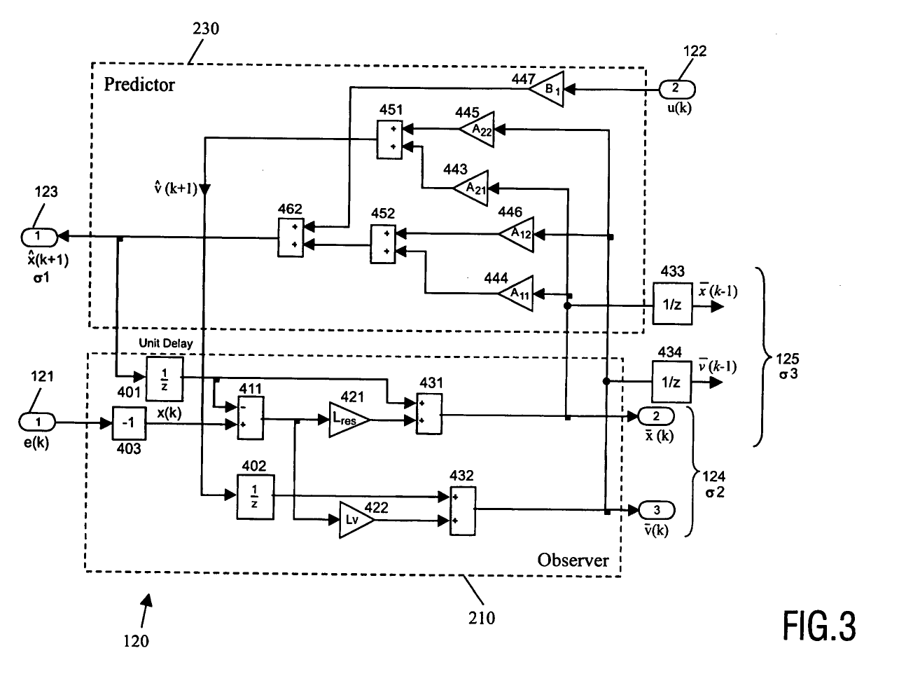

FIG. 3 shows a preferred embodiment of the state estimator 120 in more detail. In this preferred embodiment, the state estimator 120 can be basically divided into two parts: a state observer 210 and a state predictor 230, closely interacting with each other. The state observer 210 receives the current error signal e(k) at first input 121, and calculates the estimated value \overline{x}(k) for the current actuator position and an estimated value \overline{v}(k) for the current actuator speed.

The state predictor 230 receives the current actuator signal u(k) at second input 122, and receives from the state observer 210 the said estimated value \overline{x}(k) and \overline{v}(k) for the current actuator position and speed, respectively, and calculates the predicted values \hat{x}(k+1) and \hat{v}(k+1) for the actuator position and the actuator speed, respectively, at next time k+1, in accordance with the following formulas:
\hat{x}(k+1)=A_{d}(1,1)\overline{x}(k)+A_{d}(1,2)\overline{v}(k)+B_{d}(1)u(k)
\hat{v}(k+1)=A_{d}(2,1)\overline{x}(k)+A_{d}(2,2)\overline{v}(k)+B_{d}(2)u(k)
where A_{d}(2×2) and B_{d}(2×1) are a constant matrix and a constant vector, respectively, for the discrete model of the radial actuator. They can be calculated from the specification of the actuator of the drive. It is noted that B_{d}(2)=0.

The predicted actuator position \hat{x}(k+1) and the predicted actuator speed \hat{v}(k+1) are passed on to the state observer 210, for calculating the estimated actuator position \overline{x}(k) and the estimated actuator speed \overline{v}(k) in accordance with the following formulas:
\overline{x}(k)=\hat{x}(k+1)/z+Lᵣₑₛ(x(k)−\hat{x}(k+1)/z)
\overline{v}(k)=\hat{v}(k+1)/z+Lᵥ(x(k)−\hat{x}(k+1)/z)
wherein Lᵣₑₛ and Lᵥ are the estimator gains decided by the Linear Quadratic Regulator (LQR) method.

In the embodiment shown in FIG. 3, the observer 210 comprises a first unit delay block 401 receiving the predicted/estimated position \hat{x}(k+1) of the actuator from the predictor 230, and a second unit delay block 402 receiving the predicted/estimated speed \hat{v}(k+1) of the actuator from the predictor 230. The output signal of the first unit delay block 401 is passed on to an inverting input of a subtractor 411 and to an input of a first adder 431. The output signal of the second unit delay block 402 is passed on to an input of a second adder 432.

Error signal e(k) received at input 121 is passed on to an inverter 403. The output signal of the inverter 403 constitutes the current position x(k), and is passed on to a non-inverting input of the subtractor 411.

In this respect, it is noted that the error signal e(k) is defined as e(k)=X(k)−x(k), wherein X(k) indicates the desired position while x(k) indicates the actual position. Since, during tracking, the desired position X(k)=0, the actual position x(k) can be calculated as x(k)=−e(k).

The output signal of the subtractor 411 is passed on to an inverting input of a subtractor 411 and to a first amplifier 421 to be multiplied by a gain Lᵣₑₛ, and to a second amplifier 422 to be multiplied by a gain Lᵥ. The output signal of the first amplifier 421 is passed on to a second input of the first adder 431. The output signal of the second amplifier 422 is passed on to a second input of the second adder 432. At the second output 124 of the state estimator 120, the output signal of the first adder 431 is provided as output signal \overline{x}(k) (estimated current position) and the output signal of the second adder 432 is provided as output signal \overline{v}(k) (estimated current speed).

The output signal of the first adder 431 is passed on to a second unit delay block 433, and the output signal of the second adder 432 is passed on to a third unit delay block 434. At the third output 125 of the state estimator 120, the output signal of the second unit delay block 433 is provided as output signal \overline{x}(k−1) (estimated position at previous time), and the output signal of the third unit delay block 434 is provided as output signal \overline{v}(k−1) (estimated speed at previous time).

The output signal of the first adder 431 (estimated current position \overline{x}(k)) is passed on to a third amplifier 443 to be multiplied by a gain Ad(2,1), and to a fourth amplifier 444 to be multiplied by a gain Ad(1,1). The output signal of the third amplifier 443 is passed on to an input of a third adder 451. The output signal of the fourth amplifier 444 is passed on to an input of a fourth adder 452.

The output signal of the second adder 432 (estimated current speed \overline{v}(k)) is passed on to a fifth amplifier 445 to be multiplied by a gain Ad(2,2), and to a sixth amplifier 446 to be multiplied by a gain Ad(1,2). The output signal of the fifth amplifier 445 is passed on to a second input of the third adder 451. The output signal of the sixth amplifier 446 is passed on to a second input of the fourth adder 452.

Signal u(k) received at input 122 is passed on to a seventh amplifier 447 to be multiplied by a gain B_{d}(1). The output signal of the seventh amplifier 447 is passed on to an input of a fifth adder 462. The output signal of the fourth adder 452 is passed on to a second input of the fifth adder 462.

The output signal of the third adder 451 is provided as predicted speed \hat{v}(k+1) to the second unit delay block 402 of the observer 210. The output signal of the fifth adder 462 is provided as predicted position \hat{x}(k+1) to the first unit delay block 401 of the observer 210, and as first output signal σ1 at the first output 123.

Assume that the disturbance like external shock and vibration is bounded and considerably slower than the sampling frequency of the components of the SMC controller 190 (typically 22 kHz). The estimated value \overline{d}(k) of disturbances at time k can be then considered in relation to the historical values of position, speed and actuator signal at time k−1, and can be calculated as:
\overline{d}(k)=\overline{x}(k)−A_{d}(1,1)\overline{x}(k−1)−A_{d}(1,2)\overline{v}(k−1)−B_{d}(1)u(k−1)

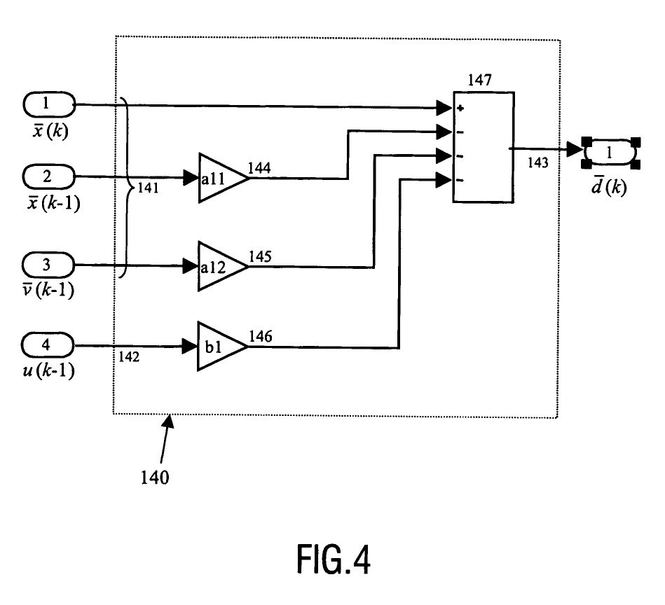

FIG. 4 is a block diagram showing a possible embodiment of the disturbance estimator 140. The signals \overline{x}(k), \overline{x}(k−1), and \overline{v}(k−1) are received at the first input 141 (third output signal σ3 from the error signal processing block 120).

Signal u(k−1) is received at the second input 142 (output signal u(k−1) from SMC controller 190). Signal \overline{x}(k) is passed on to a non-inverting input of an adder/subtractor 147. Signal \overline{x}(k−1) is passed on to a first amplifier 144 to be multiplied by a gain Ad(1,1); the output signal of the first amplifier 144 is passed on to a first inverting input of the adder/subtractor 147. Signal \overline{v}(k−1) is passed on to a second amplifier 145 to be multiplied by a gain Ad(1,2); the output signal of the second amplifier 145 is passed on to a second inverting input of the adder/subtractor 147. Signal u(k−1) is passed on to a third amplifier 146 to be multiplied by a gain Bd(1); the output signal of the third amplifier 146 is passed on to a third inverting input of the adder/subtractor 147. The output signal of the adder/subtractor 147 is provided as output signal \overline{d}(k) at the output 143 of the disturbance estimator 140.

Sliding Mode Control is a technique which is known per se. Therefore, an elaborate explanation of this technique is not necessary here. It will be sufficient to mention the following.

Sliding mode control is a robust non-linear control technique that replaces N-th order problems by equivalent 1^{st} order problems. For radial tracking, the design objective is to keep x(k)=x_{d}(k) for perfect tracking. (Here x(k)=[x(k)V(k)]^{T} is the state vector of the radial actuator. The desired state of actuator/laser spot during tracking for fine actuator control loop is: x_{d}(k)=[0 0]^{T} The radial error signal is defined as e(k)=x_{d}(k)−x(k).) This is equivalent to that of remaining on the surface S(k)=gᵣₑₛx(k)+gᵥv(k)=0 for all k>0; this surface is called the sliding surface. The problem of tracking 2-dimensional vector x_{d}(k) is now replaced by a 1^{st} order stabilisation problem in S. The goal is to design the control law such that it forces the system to converge into the sliding surface S(k) and then stay on the surface. For practical implementation, a finite-time reaching phase to the sliding surface existed due to unmatched initial condition of the states x_{d}(0)≠x(0). In order to account for modelling imprecisions and disturbances (we do not know the system perfectly), and smoothing out the discontinuous control law, a boundary layer around the sliding surface is thus defined such that the system states should move to the sliding surface or its neighbourhood from any initial condition, and eventually converge to the surface or its neighbourhood. By the Lyapunov Stability Theory, the reaching condition to guarantee the existence of the sliding surface for the optical disc drive radial tracking control system is:

$$S ( k + 1 ) = ( 1 - η ) S ( k ) - ɛ sat ( \frac{S ( k )}{Φ} ) .$$

Where η is the positive constant determining the response in the reaching stage, and should probably decided according to the actuator sensitivity. Φ is a positive constant and is called the boundary layer thickness and decided by the maximum allowable radial error to keep tracking (which is usually set to ¼ of track pitch value). And ε is the control gain of SMC. The control law to steer the actuator from any initial condition to the sliding surface (which can be deduced from the reaching condition and the drive model) is:

$$u ( k ) = k \cdot [ ɛ sat ( \frac{{g}_{res} \overline{x} ( k ) + {g}_{v} \overline{v} ( k )}{Φ} ) + {kk}_{1} \overline{x} ( k ) + {kk}_{2} \overline{v} ( k ) + \overline{d} ( k ) ]$$

where kk₁ and kk₂ and k are coefficients determined by the actuator dynamic characteristics and the SMC controller gains.

The sliding surface (S(k)=gᵣₑₛ·x(k)+gᵥ·v(k)=0) is a time-invariant surface in the state space. The constants “gᵣₑₛ” and “gᵥ” are such selected that S(k)=0 defines a stable sliding surface, where the actuator desired tracking position is invariant to disturbances or dynamic uncertainties. This means by proper choosing the control force, a total invariance to disturbances and dynamic uncertainties can be achieved on this sliding surface according to the theory of variable structure systems.

The boundary layer refers to the surrounding area around the sliding surface. That is the neighborhood area around the desired tracking position of the actuator. It is such defined that the discontinued (due to the function of sat( )) control force to bring the actuator from any initial state or disturbed state back to the sliding surface is more smoothly.

The key point in the SMC controller design is to maintain certain performance characteristics within the linear region, such as phase margin, gain margin, and sensor noise rejection by maintaining the same cross over frequency for the SMC controller as that of the traditional PID controller when operating within the boundary layer. When operating outside of the boundary layer, a higher SMC gain is used.

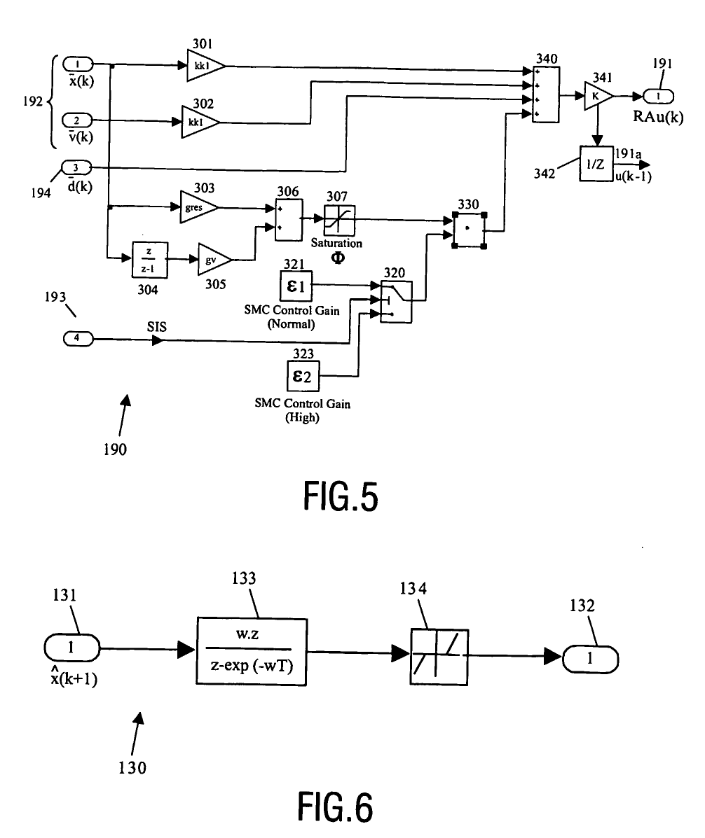

FIG. 5 is a block diagram showing an embodiment of the SMC controller 190 implemented model in digital servo blocks. The signals \overline{x}(k) and \overline{v}(k) are received at the first input 192 (second output signal signal σ2 from the error signal processing block 120). Signal \overline{d}(k) is received at the third input 194 (output signal \overline{d}(k) from disturbance estimator 140). Signal \overline{x}(k) is passed on to a first amplifier 301 to be multiplied by a gain kk1; the output signal of the first amplifier 301 is passed on to a first input of an adder 340. Signal \overline{v}(k) is passed on to a second amplifier 302 to be multiplied by a gain kk1; the output signal of the second amplifier 302 is passed on to a second input of the adder 340. Signal \overline{d}(k) is passed on to a third input of the adder 340.

Signal \overline{x}(k) is also passed on to a third amplifier 303 to be multiplied by a gain gᵣₑₛ, and to the input of a discrete transfer function block 304, executing the function z/(z−1). The output signal of the discrete transfer function block 304 is passed on to a fourth amplifier 305 to be multiplied by a gain gᵥ. The output signals of the third amplifier 303 and of the fourth amplifier 305 are passed on to respective inputs of a second adder 306. The output signal of the second adder 306 is passed on to the input of a saturation calculator 307, calculating the function sat(ξ/Φ), ξ representing the input signal to the saturation calculator 307, and Φ being said boundary layer thickness. The output signal of the saturation calculator 307 is passed on to a first input of a dot product calculator 330.

The shock indication signal SIS received at the second input 193 is passed on to a control input of a controllable switch 320. At a first signal input, the switch 320 receives a first gain value ε1 to be used in normal operation. At a second signal input, the switch 320 receives a second gain value ε2 higher than ε1. The output signal of the controllable switch 320 is passed on to a second input of the dot product calculator 330. The output signal of the dot product calculator 330 is passed on to a fourth input of the adder 340.

The output signal of the adder 340 is passed on to a fifth amplifier 341 to be multiplied by a gain K. The output signal of the fifth amplifier 341 is provided as output signal u(k) at the output 191 of the SMC controller 190. The output signal of the fifth amplifier 341 is passed on to a delay block 342; the output signal of the delay block 342 is provided as output signal u(k−1) at the output 191a of the SMC controller 190.

During normal operation, the controllable switch 320 outputs the signal ε1 received at its first signal input. When the shock indication signal SIS indicates the occurrence of a shock, the controllable switch 320 outputs the higher signal ε2 received at its second signal input.

FIG. 6 is a block diagram showing an embodiment of the shock detector 130.

The shock detector 130 comprises a low pass filter 133 and a comparator 134. The predicted position signal \hat{x}(k+1) of next time k+1, received at input 131 from the state estimator 120 (first output signal σ1 from the error signal processing block 120) is passed on to the input of the low pass filter 133 (of 850 Hz). The output signal of the low pass filter 133 is passed on to the comparator 134 to be compared with a threshold value; in this embodiment, the threshold value was set at 1/4 of track pitch. The output signal of the comparator 134 is provided as shock indication signal SIS at the output 132 of the shock detector 130.

When the radial error information is greater than ¼ of track pitch, the shock detector 130 will output a shock indication signal SIS having a magnitude indicating the occurrence of a shock, which will be interpreted by the controllable switch 320 of the SMC controller 190 so that the controllable switch 320 will select the high gain ε2 (the said second gain setting) for the SMC controller 190 to pull the actuator back to the centre of the track. When the shock detector 130 detects that the radial error signal is less than the ¼ of the track pitch value, the radial actuator control will then switch back to the normal gain ε1 (the said first gain setting) for the SMC controller.

The implementation block in FIG. 6 is the control law deducted from the reaching condition that guarantees the existence of the stable sliding surface based on the Lyapunov Stability Theory. It can be mathematically represented as:

$$u ( k ) = {( {gb}_{d} )}^{- 1} \{ εε sat \frac{\overline{S} ( k )}{Φ} ) + g [ ( ( 1 - η ) I + {A}_{d} ) \overline{x} ( k ) + \overline{d} ( k ) \}$$

where bd and Ad are the constant matrix decided by the dynamic characteristics of the actuator. As expressed in the below state space expression of the radial actuator:
x(k+1)=A_{d}x(k)+b_{d}u(k)+d(k)
y(k)=c_{d}x(k)

Switching from low gain to high gain actually makes that the controller has more power to bring the actuator back to the sliding surface, the desired tracking position, more quickly.

If the system would always use high gain, there would be more power consumption which will shorten the chip and actuator life time. Too high gain servo control system will make the servo very sensitivity to disc defects like finger prints.

The high gain will be maintained until the radial error signal is reduced to less than 25% peak off-track value (i.e. ¼ of track pitch). The HF information signal is no more reliable if the laser spot is more than ¼ track pitch value. So in the SMC controller, we set the shock detector threshold to ¼ or lower of track pitch (that is about 25% or lower peak off-track value) and switch the controller to high gain and immediately (one sample time delay) bring the radial error towards zero.

The gain switching is triggered by the observer-based shock detector which can predict the increasing trend of the radial error of more than 25% peak off-track one step ahead of the time and instantly take action to bring the actuator back to the track before it goes up.

### EXAMPLE

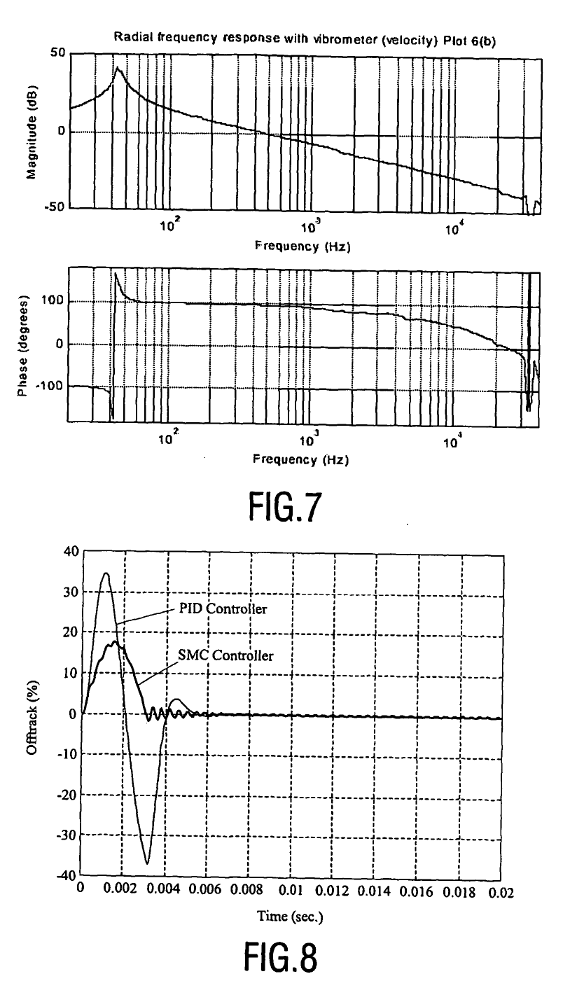

As an example, an experimental simulation has been conducted on a DVD player. FIG. 7 shows the Bode plot of the radial actuator for the drive. The initial value of the estimator gains are decided by the LQR method and the final gain values for the DVD player drive radial actuator are decided on pole placement by trial and error as:
Lᵣₑₛ=1.3e4; Lᵥ=1.7241e6

The linear controller gains for the radial actuator during tracking for the DVD player drive are:
gᵣₑₛ=1.e2; gᵥ=1.6e4; ε=600
where the control gain e of SMC controller is determined such that the whole system gives about the same crossover frequency as that of the original PID controller, that is 2.2 kHz, when the radial error is within the boundary area. Here, a boundary of 1000 is used, this is corresponding to a threshold value of 20% peak off-track (⅕ of track pitch value). When the system is operating outside the boundary layer, like when experiencing a shock/impact, and the radial error intends to become to more than ⅕ track pitch, which is out of the control range of the normal PID controller, the shock detector will immediately detect the case from the state estimator one sample time ahead. The SMC controller will then switch to a higher SMC control gain and brings the tracking error to the bounded area.

A formalised acceleration profile of a half-sine is chosen to represent the typical shock disturbances in Audio/Video applications.

FIG. 8 is a graph showing the simulated results of the radial error signal off-track value in a case of shock. The vertical axis represents off-track value (%), the horizontal axis represents time. The peak off-track value of the original PID controller is 34.6% and it is reduced to 17.7% when the SMC controller is used.

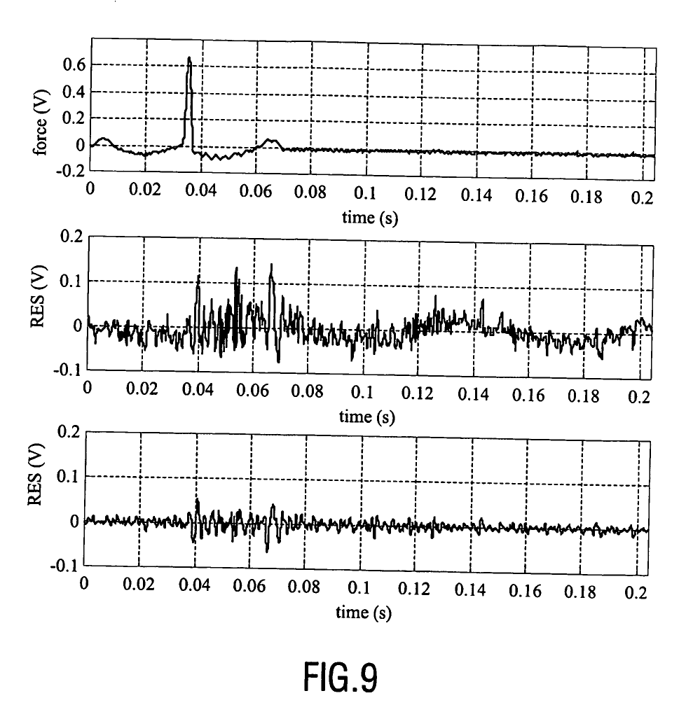

FIG. 9 is a graph showing the radial error signal RES with (middle graph) and without (lower graph) SMC controller under 7 gm/300 ms with experimental data. The measured radial actuator sensitivity is around 0.65 μm/V during playing at 1.2× DVD. The typical track pitch of DVD disc is 0.74 μm. As can be seen from the plots, the peak off-track value without and with the SMC controller is reduced from 28.1% to 8.7%.

From the above simulation and experimental results done on the DVD driver, the Estimator-based SMC with different control gain to compensate high vibration and shock shows a high level of immunity to unexpected external disturbances. Playability testing results in radial direction shows that the shock performance specification can be improved from 4 gm/300 ms to 7 gm/300 ms. This method will improve the compact disc systems, especially those with high requirements on the anti-shock performance, like portable CD/DVD player, Car CD/DVD players, etc., without any increase of the material or process cost.

It should be clear to a person skilled in the art that the present invention is not limited to the exemplary embodiments discussed above, but that several variations and modifications are possible within the protective scope of the invention as defined in the appending claims.

For instance, it is noted that the estimator based SMC controller blocks for radial tracking within the servo DSP run at 22 kHz, the servo processor clock frequency. However, other clock frequencies are possible as well.

Further, the threshold value may be adjustable, and/or set to a different value in a range from approximately 20% track pitch to approximately 25% track pitch.

Although the present invention has been described and explained in detail for radial error processing by way of example, the invention is equally applicable for focus and tilt control. In that case, the threshold value for the shock detector will typically not have a relationship to track pitch. The threshold value will be set to a predetermined level at which shock-induced displacement problems could lead to bad play of the drive; such threshold level is usually determined by experimental testing of products.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Disc drive apparatus (1) comprising:
scanning means (30) for scanning a record track of an optical disc (2) and for generating a read signal (S_{R});
actuator means (50) for controlling the positioning of at least one read/write element (34) of said scanning means (30) with respect to the disc (2);
a control circuit (90) for receiving said read signal (S_{R}) and generating at least one actuator control signal (S_{CR}, S_{CF}, S_{CT}; SAD) on the basis of at least one signal component of said read signal (S_{R});
wherein the control circuit (90) comprises:
means (111, 112) for calculating at least one error signal (RES; e(k)) on the basis of the said read signal (S_{R});
error signal processing means (120) for receiving said at least one error signal (RES; e(k)) and for outputting derived signals (σ1, σ2, σ3);
shock detector means (130) for generating a shock indication signal (SIS);
actuator control signal generator means (190) having at least one variable control parameter, for receiving one (σ2) of said derived signals from said error signal processing means (120) and for processing this derived signal for generating an actuator signal (RAD; u(k));
the actuator control signal generator means (190) being coupled to receive the shock indication signal (SIS) from the shock detector means (130), the actuator control signal generator means (190) being designed to set a first value for said variable control parameter during normal operation, and to set a second value for said variable control parameter when said shock indication signal (SIS) indicates the occurrence of a shock;
wherein said actuator control signal generator means (190) is designed to perform sliding mode control (SMC).

2. Disc drive apparatus according to claim 1, wherein said actuator control signal generator means (190) is designed to calculate its output signal (u(k)) according to the formula
$$u ( k ) = k \cdot [ ɛ sat ( \frac{{g}_{res} \overline{x} ( k ) + {g}_{v} \overline{v} ( k )}{Φ} ) + {kk}_{1} \overline{x} ( k ) + {kk}_{2} \overline{v} ( k ) ]$$
wherein kk1 and kk2 and k are coefficients determined by the actuator dynamic characteristics and the SMC controller gains;
wherein S(k)=gᵣₑₛ·x(k)+gᵥ·v(k)=0 describes a time-invariant surface in the state space, “gᵣₑₛ” and “gᵥ” being constants which are selected such that S(k)=0 defines a stable sliding surface;
wherein sat(gᵣₑₛ·x(k)+gᵥ·v(k)/Φ) defines a saturation function;
and wherein ε is a gain factor being the said variable control parameter of the SMC actuator control signal generator means (190);
and wherein \overline{x}(k) and \overline{v}(k) are signals representing values for the current actuator position and speed.

3. Disc drive apparatus according to claim 2, wherein said error signal processing means (120) is designed to calculate estimated values \overline{x}(k) and \overline{v}(k) for the current actuator position and speed;
wherein the actuator control signal generator means (190) is coupled to receive said estimated current actuator position and speed signals (\overline{x}(k) and \overline{v}(k)) from said error signal processing means (120);
and wherein said actuator control signal generator means (190) is designed to calculate its output signal (u(k)) on the basis of the estimated values received from said error signal processing means (120).

4. Disc drive apparatus according to claim 1, wherein said control circuit (90) further comprises:
disturbance estimator means (140) for receiving said actuator signal (RAD; u(k)) from said actuator control signal generator means (190) and for receiving a third derived signal (σ3) from said error signal processing means (120), the disturbance estimator means (140) being designed to generate an estimated disturbance signal (\overline{d}(k)) on the basis of said actuator signal (RAD; u(k)) and said third derived signal (σ3);
wherein said actuator control signal generator means (190) is coupled to receive said estimated disturbance signal (\overline{d}(k)) from the disturbance estimator means (140), said actuator control signal generator means (190) being designed to calculate its output signal on the basis of said estimated disturbance signal (\overline{d}(k)) also.

5. Disc drive apparatus according to claim 4, wherein said actuator control signal generator means (190) is designed to calculate its output signal (u(k)) according to the formula
$$u ( k ) = k \cdot [ ɛ sat ( \frac{{g}_{res} \overline{x} ( k ) + {g}_{v} \overline{v} ( k )}{Φ} ) + {kk}_{1} \overline{x} ( k ) + {kk}_{2} \overline{v} ( k ) + \overline{d} ( k ) ]$$
wherein kk1 and kk2 and k are coefficients determined by the actuator dynamic characteristics and the SMC controller gains;
wherein S(k)=gᵣₑₛ·x(k)+gᵥ·v(k)=0 describes a time-invariant surface in the state space, “gᵣₑₛ” and “gᵥ” being constants which are selected such that S(k)=0 defines a stable sliding surface;
wherein sat(gᵣₑₛ·x(k)+gᵥ·v(k)/Φ) defines a saturation function;
and wherein ε is a gain factor being the said variable control parameter of the SMC actuator control signal generator means (190);
and wherein \overline{x}(k) and \overline{v}(k) are signals representing values for the current actuator position and speed.

6. Disc drive apparatus according to claim 5, wherein said error signal processing means (120) is designed to calculate estimated values \overline{x}(k) and \overline{v}(k) for the current actuator position and speed;
wherein the actuator control signal generator means (190) is coupled to receive said estimated current actuator position and speed signals (\overline{x}(k) and \overline{v}(k)) from said error signal processing means (120);
and wherein said actuator control signal generator means (190) is designed to calculate its output signal (u(k)) on the basis of the estimated values received from said error signal processing means (120).

7. Disc drive apparatus according to claim 6, wherein said error signal processing means (120) comprises a state estimator (120) which is coupled to receive said actuator signal (RAD; u(k)) from said actuator control signal generator means (190);
wherein said state estimator (120) is designed to calculate a predicted position signal (\hat{x}(k+1)) in accordance with the formula:
\hat{x}(k+1)=A_{d}(1,1)\overline{x}(k)+A_{d}(1,2)\overline{v}(k)+B_{d}(1)u(k)
wherein said state estimator (120) is designed to calculate a predicted speed signal (\hat{v}(k+1)) in accordance with the formula:
\hat{v}(k+1)=A_{d}(2,1)\overline{x}(k)+A_{d}(2,2)\overline{v}(k)+B_{d}(2)u(k)
wherein A_{d}(2×2) and B_{d}(2×1) are constant matrices and vectors for the discrete model of the actuator;
and wherein \overline{x}(k) and \overline{v}(k) are estimated values for the current position and the current speed of the actuator, respectively;
and wherein said state estimator (120) is designed to calculate \overline{x}(k) and \overline{v}(k) in accordance with the formulas:
\overline{x}(k)=\hat{x}(k+1)/z+Lᵣₑₛ(x(k)−\hat{x}(k+1)/z)
\overline{v}(k)=\hat{v}(k+1)/z+Lᵥ(x(k)−\hat{x}(k+1)/z)
wherein Lᵣₑₛ and Lᵥ are the estimator gains, preferably determined by the Linear Quadratic Regulator (LQR) method.

8. Disc drive apparatus according to claim 7, wherein said shock detector means (130) are designed to generate said shock indication signal (SIS) on the basis of said predicted position signal (\hat{x}(k+1)).

9. Disc drive apparatus according to claim 8, wherein said shock detector means (130) comprise:
a low pass filter (133) for receiving said predicted position signal (\hat{x}(k+1)); and
a comparator (134) for receiving an output signal from said low pass filter (133) and for providing said shock indication signal (SIS).

10. Disc drive apparatus according to claim 9, wherein said low pass filter (133) has a cut-off frequency in the order of about 850 Hz.

11. Disc drive apparatus according to claim 9, wherein said comparator (134) is designed to compare the output signal from said low pass filter (133) with a predefined threshold value which, in the case of radial control, corresponds to approximately 25% of the track pitch.

12. Disc drive apparatus according to claim 9, wherein said comparator (134) is designed to compare the output signal from said low pass filter (133) with a predefined threshold value which, in the case of radial control, corresponds to approximately 20% of the track pitch.

13. Disc drive apparatus according to claim 1, wherein said actuator signal generated by said actuator control signal generator means (190) is a digital actuator signal (RAD; u(k)), and wherein said control circuit (90) further comprises:
D/A signal processing means (196) for receiving said digital actuator signal (RAD; u(k)) from said actuator control signal generator means (190) and for generating an analogue actuator signal (RAA; u(s));
preferably, noise filter means (197) for receiving said analogue actuator signal (RAA; u(s)) from said D/A signal processing means (196) and for generating a filtered actuator signal (SAF);
actuator driver means (198) for receiving said analogue actuator signal (RAA; u(s)) from said D/A signal processing means (196) or receiving said filtered actuator signal (SAF), and for generating an actuator drive signal (SAD; S_{CR}, S_{CF}, S_{CT})
